(19) United States
(12) Patent Application Publication
(10) Pub. No.: US 2010/0156557 A1
(43) Pub. Date: Jun. 24, 2010

(54) PHASE SHIFTER

(75) Inventors: Dau-Chyrh CHANG, Taipei (TW); Bing-Hao Zeng, Taichung County (TW); Ji-Chyun Liu, Taoyuan County (TW); Yunk-Chia Chou, Hsinchu City (TW); Kang-Kuei Liu, Hsinchu County (TW)

Correspondence Address: RABIN & Berdo, PC, 1101 14TH STREET, NW, SUITE 500, WASHINGTON, DC, 20005, US

(73) Assignee: SMARTANT TELECOM CO., LTD., Hsinchu (TW)

(21) Appl. No.: 12/342,826

(22) Filed: Dec. 23, 2008

(51) Int. Cl. H01P 5/12; H01P 1/18

(52) U.S. Cl. 333/136; 333/161

(57) ABSTRACT

A phase shifter includes a substrate, an input part, a plurality of first transmission lines, a plurality of second transmission lines, a coupling part, a controller, and a plurality of output parts. When a signal is fed in a first transmission line, the fed signal is distributed to a corresponding second transmission line via the first transmission line, and an area of the second transmission line shielded by the coupling part is changed by rotating the coupling part through the controller, so as to shift a phase of the signal transmitted by the second transmission line.

### BACKGROUND OF THE INVENTION

1. Field of the Invention

The present invention relates to a phase shifter, and more particularly to a phase shifter with a rotatable coupling part.

2. Related Art

With the development of wireless communication technology, the wireless communication products have become increasingly important in daily life. Besides the simple functions of transferring speeches and messages in the past, nowadays, the mass has further turned their demands on the communication products to the functions of video transmission and online browsing. Moreover, in the past, people did not pay much attention to the shapes and sizes of the products; however, nowadays, it is emphasized that the products must be light, thin, short, and small, and must support various communication services. Therefore, the communication products have developed towards the trend of supporting broadband services and multiplexing integration function. Therefore, the antennas of the communication products for transceiving signals must have wide bandwidth, so as to realize high transmission rate and provide different communication services.

Phase shifters have been widely applied in the communications, instrumentation, and control fields, but still have many problems that must be solved. For example, a phase shifter that is suitable for different base station antennas is not available. Conventionally, a phase shifter is of a metal structure, so the signal coupling efficiency is relatively poor. In addition, the phase shifter cannot output signals of multiple phases at the same time, and the signal output from the single output part of the phase shifter can be changed to different phases only through controlling the phase shifter. Moreover, the conventional phase shifter transmits signals in a contact manner, so that noises will be generated when the phase shift is changed. Finally, the conventional phase shifter has an excessive large size and has a metal structure, so it is difficult to be manufactured.

### SUMMARY OF THE INVENTION

Accordingly, the present invention is directed to a phase shifter, which solves the problem that a conventional phase shifter cannot output signals of different phases at the same time, and eliminates the noises generated due to the contact manner.

A phase shifter is provided in the present invention, which includes a substrate, an input part, a plurality of first transmission lines, a plurality of second transmission lines, a coupling part, a controller, and a plurality of output parts. The input part is disposed on the substrate, for receiving a signal. The plurality of first transmission lines is disposed on the substrate. Each of the plurality of first transmission lines is respectively coupled to the input part, so as to transmit the signal received by the input part. The plurality of second transmission lines is disposed on the substrate. A first end of each of the second transmission lines is electrically connected to each of the first transmission lines respectively, so as to receive and transmit the signal output by each of the corresponding first transmission line. The coupling part is disposed corresponding to the second transmission lines, and rotates with respect to the second transmission lines. The coupling part is rotated to change an area of the second transmission lines shielded by the coupling part, such that after the signal received by each of the second transmission line is coupled by the coupling part, the phase of the signal transmitted by each of the second transmission line is changed. The controller is connected to the coupling part for controlling the coupling part to rotate. The plurality of output parts is disposed on the substrate. Each of the plurality of output parts is electrically connected to a second end of each of the second transmission lines, so as to receive the signal output by each of the corresponding second transmission line.

The phase shifter further includes a plurality of power distribution units electrically connected to the plurality of first transmission lines, so as to distribute the signal received by the input part to the plurality of first transmission lines for transmission.

The phase shifter of the present invention uses the controller to control the coupling part to rotate, so as to shield different areas of the second transmission lines. Thus, when each of the second transmission line receives the signal, as the coupling part shields different areas of each of the second transmission lines, the second transmission line outputs the signals of different phases. Moreover, the phases of the signals output by the second transmission lines can be changed by rotating the coupling part.

The features and practice of the present invention can be described below in detail through preferred embodiments with reference to the accompanying drawings.

### BRIEF DESCRIPTION OF THE DRAWINGS

The present invention will become more fully understood from the detailed description given herein below for illustration only, and thus is not limitative of the present invention, and wherein:

FIG. 1 is a schematic view of a first embodiment of the present invention;

FIG. 2 is another schematic view of the first embodiment of the present invention;

FIG. 3 is a schematic view of a second embodiment of the present invention; and

FIG. 4 is another schematic view of the second embodiment of the present invention.

### DETAILED DESCRIPTION OF THE INVENTION

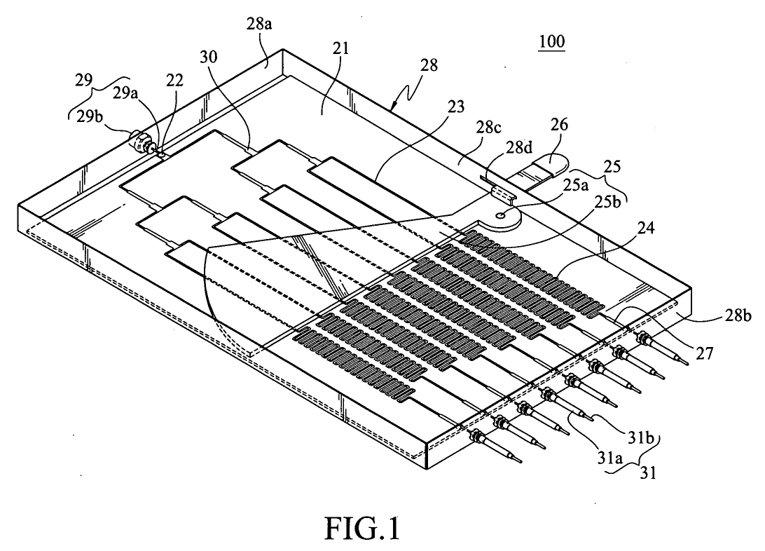

FIG. 1 is a schematic view of a phase shifter according to a first embodiment of the present invention. Referring to FIG. 1, a phase shifter 100 includes a substrate 21, an input part 22, a plurality of first transmission lines 23, a plurality of second transmission lines 24, a coupling part 25, a controller 26, and a plurality of output parts 27.

The input part 22 is disposed on the substrate 21, for receiving a signal.

The first transmission lines 23 are disposed on the substrate 21. Each of the first transmission line 23 is respectively coupled to the input part 22, and transmits the signal received by the input part 22.

The phase shifter 100 further includes a plurality of power distribution units 30. One end of each of the power distribution units 30 is electrically connected to the input part 22, and the other end of each of the power distribution units 30 is electrically connected to each of the first transmission lines 23. The power distribution units 30 distribute the signals received by the input part 22 to the first transmission lines 23.

The second transmission lines 24 are disposed on the substrate 21. A first end of each of the second transmission lines 24 is electrically connected to each of the first transmission lines 23. Each of the second transmission lines 24 receives and transmits the signal output by each of the corresponding first transmission line 23. The second transmission lines 24 have different lengths, and are disposed on the substrate in parallel.

The coupling part 25 is disposed corresponding to the plurality of second transmission lines 24. The controller 26 is connected to the coupling part 25 for controlling the coupling part 25 to rotate with respect to the plurality of second transmission lines 24. By rotating the coupling part 25, the areas of the plurality of second transmission lines 24 shielded by the coupling part 25 are changed, so as to change the phases of the signals transmitted by the second transmission lines 24. In other words, after each of the second transmission lines 24 receives the signal, the received signal is coupled by the coupling part 25, so as to change the phase of the signal transmitted by each of the second transmission lines 24.

The plurality of output parts 27 is disposed on the substrate 21. Each of the output parts 27 is electrically connected to a second end of each of the second transmission lines 24. Each of the output parts 27 receives the signal output by each of the corresponding second transmission line 24.

The phase shifter 100 further includes a casing 28. The substrate 21 is disposed within the casing 28. The casing 28 includes a signal feed-in part 29 and a plurality of signal feed-out parts 31. The signal feed-in part 29 feeds a signal in the input part 22. The signal feed-in part 29 passes through a first side plate 28a of the casing 28, and is connected to the substrate 21. The signal feed-in part 29 has an inner signal line 29a and an outer cladding metal 29b. The outer cladding metal 29b of the signal feed-in part 29 is connected to the first side plate 28a of the casing 28, and the inner signal line 29a of the signal feed-in part 29 is connected to the input part 22 on the substrate 21.

The plurality of signal feed-out parts 31 receive the signals transmitted by the output parts 27, and feeds the signals out to an antenna. The signal feed-out parts 31 pass through a second side plate 28b opposite to the first side plate 28a of the casing 28, and are connected to the substrate 21. Each of the signal feed-out parts 31 has an inner signal line 31a and an outer cladding metal 31b. The outer cladding metal 31b of each signal feed-out part 31 is connected to the second side plate 28b of the casing 28, and the inner signal line 31a of each signal feed-out part 31 is connected to each output part 27 on the substrate 21. The signal feed-out parts 31 feed out the signals from the output parts 27. The second transmission lines 24 are zigzagged metal circuits. Certainly, the second transmission lines 24 may also be rectangular metal circuits, or in other geometrical shapes.

Generally, the substrate 21 is a printed circuit board (PCB). The substrate 21 is made of glass fiber, bakelite or other materials. Certainly, the substrate 21 may be made of other materials.

The coupling part 25 includes a revolving shaft 25a and a dielectric board 25b. The revolving shaft 25a passes through the dielectric board 25b and the substrate 21, and is connected to the dielectric board 25b. Certainly, the revolving shaft 25a further passes through the casing 28. The controller 26 is connected to the revolving shaft 25a. When the controller 26 rotates the revolving shaft 25a, the dielectric board 25b is driven to rotate accordingly. The dielectric board 25b may be triangular, semicircular, semielliptical, or polygonal in shape.

The controller 26 is a stepper motor or a stepper hinge connected to of the revolving shaft 25a. The controller 26 may be disposed below the casing 28 and connected to the revolving shaft 25a, such that the controller 26 rotates the revolving shaft 25a to drive the dielectric board 25b to rotate. Alternatively, a slot 28d is opened in a third side plate 28c of the casing 28, and the controller 26 passes through the slot 28d and is connected to the revolving shaft 25a, such that the controller 26 rotates the revolving shaft 25a to drive the dielectric board 25b to rotate.

The second transmission lines 24 are arranged in parallel, and the first ends (that is, the ends connected to the first transmission lines 23) of the second transmission lines 24 are aligned with each other and arranged along a straight line. As for the second transmission line 24 with the first end being closest to the revolving shaft of the coupling part 25, the second end thereof is closest to the corresponding output part 27. Moreover, the greater the distance between the first end of the second transmission line 24 and the revolving shaft of the coupling part 25 is, the greater the distance between the second end of the second transmission line 24 and the corresponding output part 27 will be. However, as for the second transmission line 24 with the first end being farthest from the revolving shaft of the coupling part 25, the second end thereof is closer to the corresponding output part 27 than that of the second transmission line 24 with the first end being less farthest from the revolving shaft of the coupling part 25.

In this embodiment, when an external signal is received, the signal is fed in the input part 22 on the substrate 21 through the signal feed-in part 29 on the casing 28. The signal fed in through the feed-in part is input to the power distribution units 30, and transmitted to each of the first transmission lines 23 through the power distribution units 30. Then, the first transmission line 23 transmits the signal to the corresponding second transmission line 24. At this time, the coupling part 25 is controlled by rotating the controller 26, such that the coupling part 25 shields different areas of the second transmission lines 24. Thus, the signal transmitted on each of the second transmission lines 24 is coupled by the coupling part 25, so as to change the phase. Then, the output parts 27 connected to the second transmission lines 24 transmit the signals of different phases to the signal feed-out parts 31 on the casing 28, such that the signal feed-out parts 31 feed out the signals.

As the coupling part 25 shields different areas of the plurality of second transmission lines 24, the phase shifter 100 outputs the signals of different phases at the same time. Furthermore, the coupling part 25 generates the phase change in a non-contact manner, so that the noises are not generated. In addition, the phase change of the signals generated by the phase shifter 100 are directly realized by rotating the coupling part 25 through the controller 26, so the manufacturing process is simplified, and the size of the phase shifter is reduced.

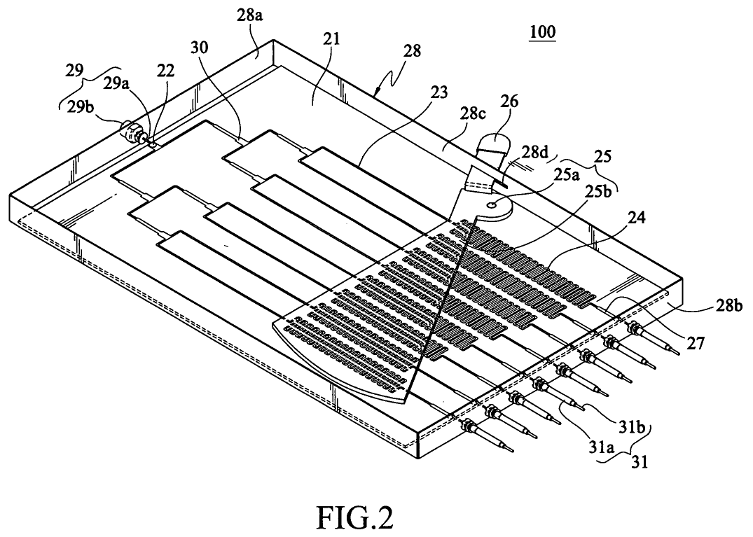

FIG. 2 is a schematic view of the phase shifter in another operating status according to the first embodiment of the present invention. Referring to FIGS. 2 and 1, the position where the coupling part 25 shields the second transmission line 24 is changed in FIG. 2 as compared with that in FIG. 1, so the area of the second transmission line 24 shielded by the coupling part 24 is also different from that in FIG. 1. Therefore, in FIGS. 1 and 2, the phases of the signals output by the second transmission lines 24 are also different.

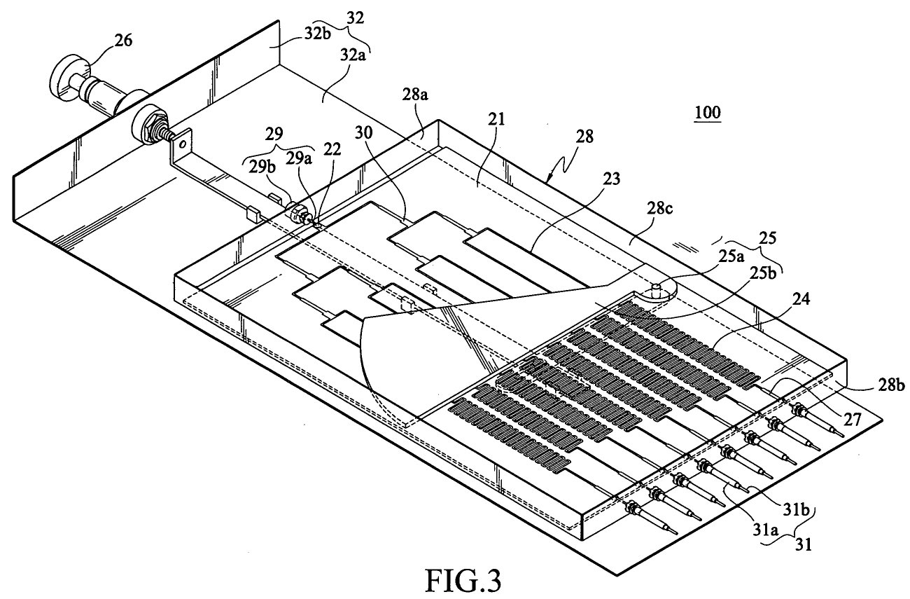

FIG. 3 is a schematic view of a phase shifter according to a second embodiment of the present invention. The structure of the phase shifter 100 in this embodiment has been disclosed in the first embodiment, so the same parts can be obtained through comparison, which will not be described again here. In this embodiment, the phase shifter 100 further includes a base 32.

The base 32 includes a bottom plate 32a and a side plate 32b. The bottom plate 32a is disposed below the casing 28 and connected to the casing 28, so as to fix the casing 28 above the bottom plate 32a. Thus, the casing 28 is fixed above the bottom plate 32a through a fastener structure such as a bolt or a support pillar, and the casing 28 is supported to keep a distance from the bottom plate 32a.

The side plate 32b is connected to the bottom plate 32a, and is adjacent to one side of the bottom plate 32a. The controller 26 is disposed on the side plate 32b, and connected to the revolving shaft 25a through an interlocking shaft, such that the controller 26 controls the interlocking shaft to rotate and drives the revolving shaft 25a to rotate accordingly, and further drives the dielectric board 25b to rotate.

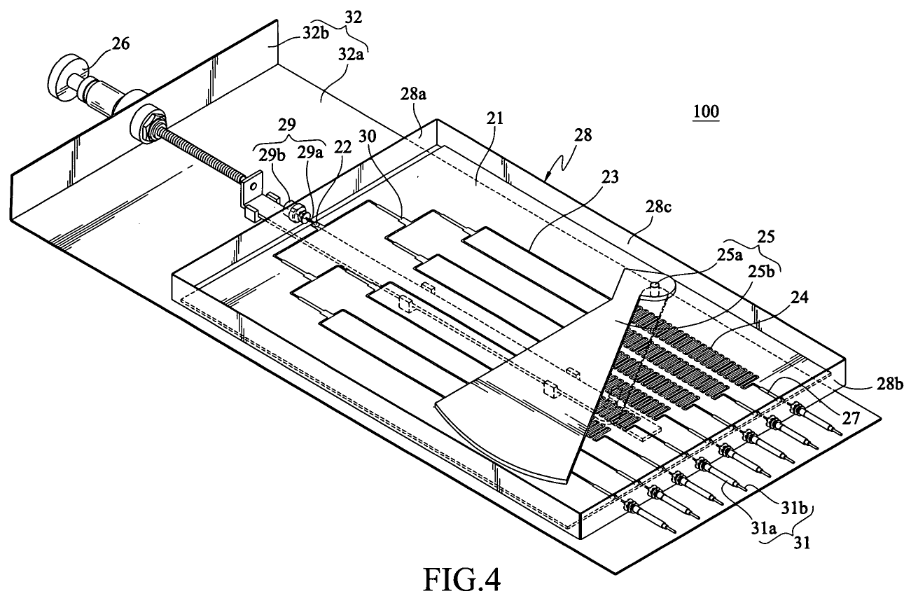

FIG. 4 is a schematic view of the phase shifter in another operating status according to the second embodiment of the present invention. Referring to FIGS. 4 and 3, the position where the coupling part 25 shields each of the second transmission line 24 is changed in FIG. 4 as compared with that in FIG. 3, so that the area of the second transmission line 24 shielded by the coupling part 25 is also different from that in FIG. 3. Therefore, in FIGS. 3 and 4, the phases of the signals output by the second transmission lines 24 are different.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A phase shifter, comprising:
a substrate;
an input part, disposed on the substrate, for receiving a signal;
a plurality of first transmission lines, disposed on the substrate, wherein the plurality of first transmission lines is coupled to the input part, and transmits the signal received by the input part;
a plurality of second transmission lines, disposed on the substrate, wherein a first end of each of the second transmission lines is electrically connected to each of the first transmission lines, so as to receive and transmit the signal output by each of the corresponding first transmission line;
a coupling part, disposed corresponding to the plurality of second transmission lines, and rotating with respect to the plurality of second transmission lines, wherein the coupling part is rotated to change an area of the plurality of second transmission lines shielded by the coupling part, such that after the signal received by each of the second transmission line is coupled by the coupling part, a phase of the signal transmitted by each of the second transmission line is changed;
a controller, connected to the coupling part, for controlling the coupling part to rotate; and
a plurality of output parts, disposed on the substrate, wherein each of the output parts is electrically connected to a second end of each of the second transmission lines, so as to receive the signal output by each of the corresponding second transmission line.

2. The phase shifter as claimed in claim 1, wherein each of the second transmission lines is a zigzagged metal circuit or a rectangular metal circuit.

3. The phase shifter as claimed in claim 1, comprising: a plurality of power distribution units, wherein one end of each of the plurality of power distribution units is electrically connected to the input part, and the other end thereof is electrically connected to each of the plurality of first transmission lines, so as to distribute the signal received by the input part to the plurality of first transmission lines for transmission.

4. The phase shifter as claimed in claim 1, wherein the second transmission lines have different lengths, and are disposed on the substrate in parallel.

5. The phase shifter as claimed in claim 1, wherein the coupling part is a rectangular dielectric board, semicircular dielectric board, semielliptical dielectric board, or polygonal dielectric board.

6. The phase shifter as claimed in claim 1, wherein the phase shifter is disposed within a casing.

7. The phase shifter as claimed in claim 6, wherein the casing comprises a signal feed-in part for feeding the signal into the input part.

8. The phase shifter as claimed in claim 6, wherein the casing comprises a plurality of signal feed-out parts for receiving the signal transmitted by the plurality of output parts, and feeding out the signal.

9. The phase shifter as claimed in claim 6, wherein the controller is disposed on the casing.

10. The phase shifter as claimed in claim 6, further comprising: a base, wherein the base comprises:
a bottom plate, disposed below the casing and connected to the casing, so as to fix the casing on the bottom plate; and
a side wall, adjacent to the bottom plate.

11. The phase shifter as claimed in claim 10, wherein the controller is disposed on the base.
